(19) United States
(12) Patent Application Publication
(10) Pub. No.: US 2014/0340396 A1
(43) Pub. Date: Nov. 20, 2014

(54) METHOD OF REPRESENTING ENVIRONMENT OBJECT IN CYBER-PHYSICAL SYSTEM USING ENVIRONMENT DATA MODEL STRUCTURE AND COMPUTER-READABLE STORAGE MEDIUM STORING PROGRAM THEREFOR

(71) Applicant: Electronics and Telecommunications Research Institute, Daejeon (KR)

(72) Inventors: Jae-Ho JEON, Ulsan (KR); In-Geol CHUN, Seoul (KR); Won-Tae KIM, Asan (KR)

(73) Assignee: Electronics and Telecommunications Research Institute, Daejeon (KR)

(21) Appl. No.: 14/252,495

(22) Filed: Apr. 14, 2014

(30) Foreign Application Priority Data
May 14, 2013 (KR) 10-2013-0054443

(51) Int. Cl. G06T 17/00

(52) U.S. Cl. CPC G06T 17/00
USPC 345/420

(57) ABSTRACT

Disclosed herein are a method of representing an environment object in a cyber-physical system using an environment data model structure and a computer-readable storage medium storing a program therefor. A library model for storing information required to visualize environment data as an environment object in a cyber-physical system is generated. A geometry representation model having geometry structure information of the environment data is generated. A feature representation model having two-dimensional (2D) or three-dimensional (3D) information of the environment data is generated. A model structure of the environment data including the library model, the geometry representation model, and the feature representation model is configured. An environment data file having information about the model structure of the environment data is stored in a database (DB). The environment object in the cyber-physical system is visually represented using the environment data file stored in the DB.

### CROSS REFERENCE TO RELATED APPLICATION

This application claims the benefit of Korean Patent Application No. 10-2013-0054443 filed on May 14, 2013, which is hereby incorporated by reference in its entirety into this application.

### BACKGROUND OF THE INVENTION

1. Technical Field

The present invention relates generally to a method of representing an environment object in a cyber-physical system using an environment data model structure and a computer-readable storage medium storing a program therefor and, more particularly, to a method of representing an environment object in a cyber-physical system using an environment data model structure that is defined to reuse pieces of environment data required to represent environment objects between domains in a model-based large-scale cyber-physical system, and to a computer-readable storage medium storing a program for the method.

2. Description of the Related Art

A Cyber-Physical System (CPS) denotes a system for guaranteeing the reliability, real-time features, intelligence, etc. of software so as to prevent the occurrence of unexpected errors and situations, as a real world system and a computing system are associated with each other and the complexity thereof has increased. A CPS denotes a hybrid system in which a plurality of embedded systems are combined based on a network, and has the characteristics of both continuous elements such as physical, electrical, and analog elements, and discrete elements such as electronic and software elements.

As an attempt to standardize control and management of a cyber-physical system, there is dynamic control management technology which allows systems in different networks constituting a cyber-physical system to be organically integrated, and which is disclosed in Korean Patent Application Publication No. 2011-0097269, etc. However, standardization attempts for a conventional cyber-physical system such as that disclosed in Korean Patent Application Publication No. 2011-0097269, etc. are limited to research into technology for overcoming differences between systems or networks that constitute the cyber-physical system, and intending to realize integration using unified rules.

Recently, with the development of information and communication industry, the utilization and necessity of visual representation technology for various environment objects (natural objects or artificial objects) in a cyber-physical system has gradually increased. Further, pieces of environment data required to visualize such an environment object have been widely utilized in various application fields, such as construction, military war-games, weather, human body images, and engineering simulations, to which the cyber-physical system is applied. However, there is a problem in that pieces of environment data about environment objects are limitedly utilized only in a specific domain, thus making it difficult to reuse environment data between domains.

### SUMMARY OF THE INVENTION

Accordingly, the present invention has been made keeping in mind the above problems occurring in the prior art, and an object of the present invention is to define an integrated environment that may be utilized in a cyber-physical system, and present a model structure of environment data required to represent an environment object, so that environment data developed in a specific domain environment may be efficiently managed, and environment data developed between domains may be commonly utilized, thus reducing cost and time required by a developer to design a cyber-physical system.

In accordance with an aspect of the present invention to accomplish the above object, there is provided a method of representing an environment object in a cyber-physical system using an environment data model structure, including generating a library model for storing information required to visualize environment data as an environment object in a cyber-physical system; generating a geometry representation model having geometry structure information of the environment data; generating a feature representation model having two-dimensional (2D) or three-dimensional (3D) information of the environment data; configuring a model structure of the environment data including the library model, the geometry representation model, and the feature representation model; storing an environment data file having information about the model structure of the environment data in a database (DB); and visually representing the environment object in the cyber-physical system using the environment data file stored in the DB.

Preferably, generating the geometry representation model may include generating a geometry model instance indicative of a model instance having geometry structure information of the environment data.

Preferably, the geometry model instance may be represented by at least three polygon instances.

Preferably, generating the geometry representation model may further include generating a reference model indicative of a reference relation between geometry model instances; generating an identification model having identification information of the geometry model instances; and generating a data table representing geometry structure information of the environment data in a format of a table.

Preferably, the data table may be a table in which one or more of a property value, a property table, behavior, and transformation information related to a geometry structure of the environment data are represented in a format of a table.

Preferably, generating the feature representation model may include generating a feature model instance indicative of a model instance having 2D or 3D information of the environment data.

Preferably, the feature model instance may be defined by point features, linear features, areal features, or volume features.

Preferably, generating the feature representation model may further include generating a reference model indicative of a reference relation between feature model instances; generating an identification model having identification information of the feature model instances; and generating a data table representing 2D or 3D information of the environment data in a format of a table.

Preferably, the data table may be a table in which one or more of a property value, a property table, behavior, and transformation information related to 2D or 3D features of the environment data are represented in a format of a table.

In accordance with another aspect of the present invention to accomplish the above object, the method of representing an environment object in a cyber-physical system using an environment data model structure may be implemented as program instructions and may be stored in a computer-readable storage medium.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of a system for representing an environment object using an environment data model structure according to the present invention;

FIG. 2 is a diagram showing the model structure of environment data configured by the system for representing an environment object using an environment data model structure according to the present invention;

FIG. 3 is a diagram showing the structure of a lower class model for a geometry representation model shown in FIG. 2;

FIG. 4 is a diagram showing the structure of a lower class model for a feature representation model shown in FIG. 2;

FIG. 5 is a flowchart showing a method of representing an environment object in a cyber-physical system using an environment data model structure according to the present invention;

FIG. 6 is a flowchart showing in detail a procedure for generating a geometry representation model in the method of representing an environment object in a cyber-physical system using an environment data model structure according to the present invention; and

FIG. 7 is a flowchart showing in detail a procedure for generating a feature representation model in the method of representing an environment object in a cyber-physical system using an environment data model structure according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

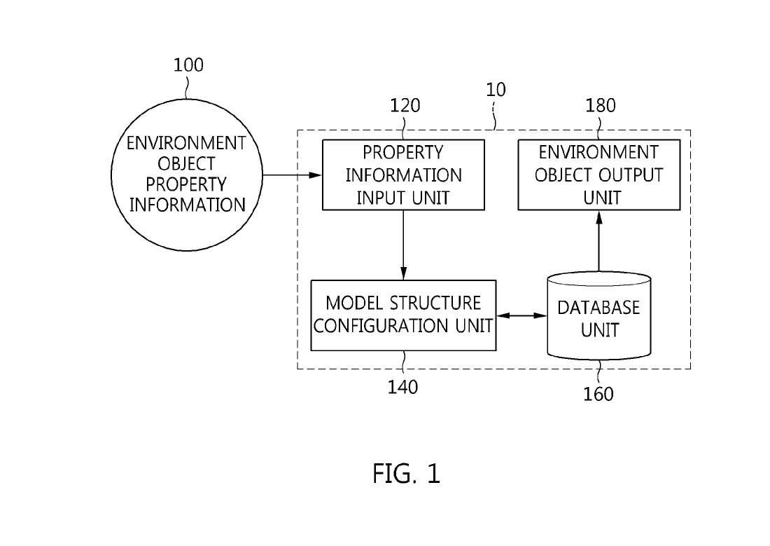

Hereinafter, the configuration and operation of a system for representing an environment object in a cyber-physical system using an environment data model structure according to the present invention will be described in detail with reference to FIGS. 1 to 4.

FIG. 1 is a block diagram showing the configuration of a system for representing an environment object in a cyber-physical system using an environment data model structure according to the present invention.

Referring to FIG. 1, a system 10 for representing an environment object in a cyber-physical system using an environment data model structure according to the present invention includes a property information input unit 120, a model structure configuration unit 140, a database (DB) unit 160, and an environment object output unit 180. The property information input unit 120 receives required property information to configure the model structure of environment data about an environment object represented by the cyber-physical system from a user. The model structure configuration unit 140 configures the model structure of the environment data based on the property information received by the property information input unit 120. The DB unit 160 stores an environment data file having information indicative of the model structure of the environment data configured by the model structure configuration unit 140. The environment object output unit 180 visually represents the environment object in the cyber-physical system by using the environment data file stored in the DB unit 160.

The property information input unit 120 receives the property information of environment data required to configure the model structure of environment data by the model structure configuration unit 140 from the user. In this case, the property information received through the property information input unit 120 may include the type, description, geometry structure, and feature information of environment data that is an object, the model structure of which is to be configured, and information required to visualize and represent the corresponding environment data in the cyber-physical system.

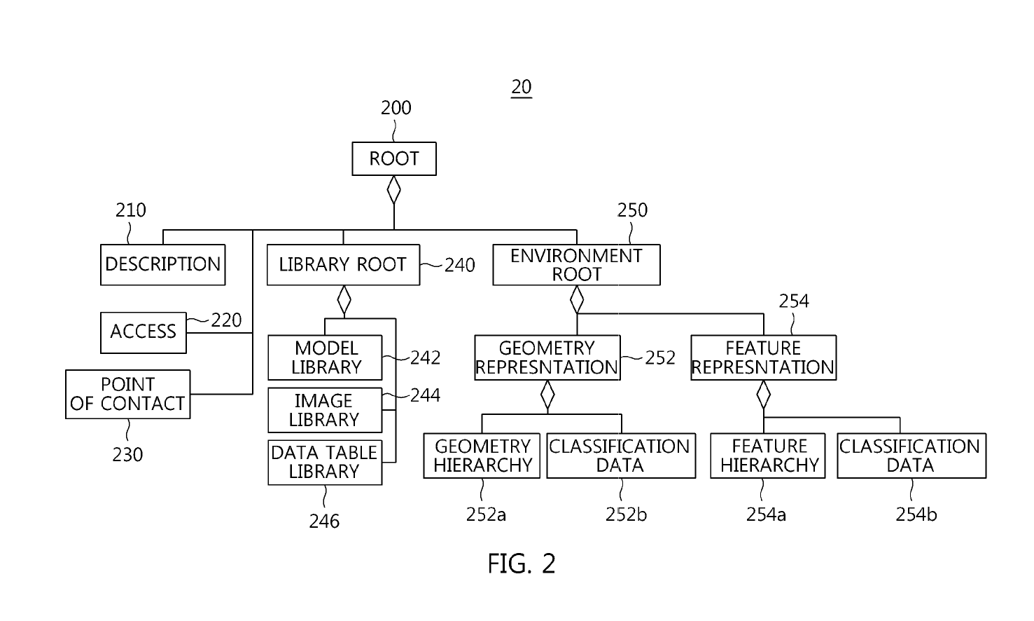

The model structure configuration unit 140 defines the model structure of environment data about a specific environment object represented in the cyber-physical system. In greater detail, the model structure configuration unit 140 configures the model structure 20 of environment data, such as that shown in FIG. 2. Referring to FIG. 2, the model structure 20 of the environment data configured by the model structure configuration unit 140 includes a root 200 as the highest class model, and includes a description model 210, an access model 220, a point-of-contact model 230, a library root model 240, and an environment root model 250 as the lower class models of the root 200.

Here, the description model 210 deals with descriptions including explanations indicating which environment is described by the corresponding environment data in the cyber-physical system. The access model 220 deals with accessibility to the corresponding environment data, wherein the environment data may be accessed only when passing through a ‘point of contact.’ The point-of-contact model 220 deals with the descriptions of a point-of-contact at which the corresponding environment data may be accessed. The library root model 240 denotes a library model for storing models, images, data tables, etc. required to represent the corresponding environment data in order to visualize the environment data in the cyber-physical system.

In this case, the model structure of the library root model 240 includes a model library 242, an image library 244, and a data table library 246 as sub-libraries for the library root model 240. The model library 242 is a gathering place of models representing environment data, and may be divided into a geometry class and a feature class. The image library 244 stores images required to represent environment data. In this case, the image library 244 essentially includes one or more images for a single piece of environment data. Further, the data table library 246 stores the actual data information of the environment data in the format of a table. For example, the data table library 246 may include the data quality, identification, mapping function, and data description information of environment data. Meanwhile, the environment root model 250 corresponds to a highest class model for entirely managing the geometry structure information and feature information of an environment object. The environment root model 250 includes a geometry representation model 252 including the geometry structure information of environment data indicative of an environment object and a feature representation model 254 including semantic information required to exactly represent the environment data. In this case, the geometry representation model 252 has a geometry hierarchy model 252a and a classification data model 252b as lower class models, and the feature representation model 254 has a feature hierarchy model 254a and a classification data model 254b as lower class models.

The DB unit 160 stores the model structure of environment data about the environment object defined by the model structure configuration unit 140 in the format of a file. That is, the DB unit 160 stores information about the model structure of the environment data configured by the model structure configuration unit 140 in the format of an environment data file, and provides the stored environment data file to the environment object output unit 180 at the request of the environment object output unit 180, thus enabling the environment object to be visually represented in the cyber-physical system.

The environment object output unit 180 is configured to, when desiring to represent a specific environment object in the cyber-physical system, extract an environment data file corresponding to the environment object stored in the DB 160, and visually represent the environment object in the cyber-physical system using the environment data file.

Below, the model structures of the geometry representation model 252 and the feature representation model 254 in the model structure 20 of the environment data configured by the model structure configuration unit 140 and stored in the format of a file in the DB 160 will be described in greater detail.

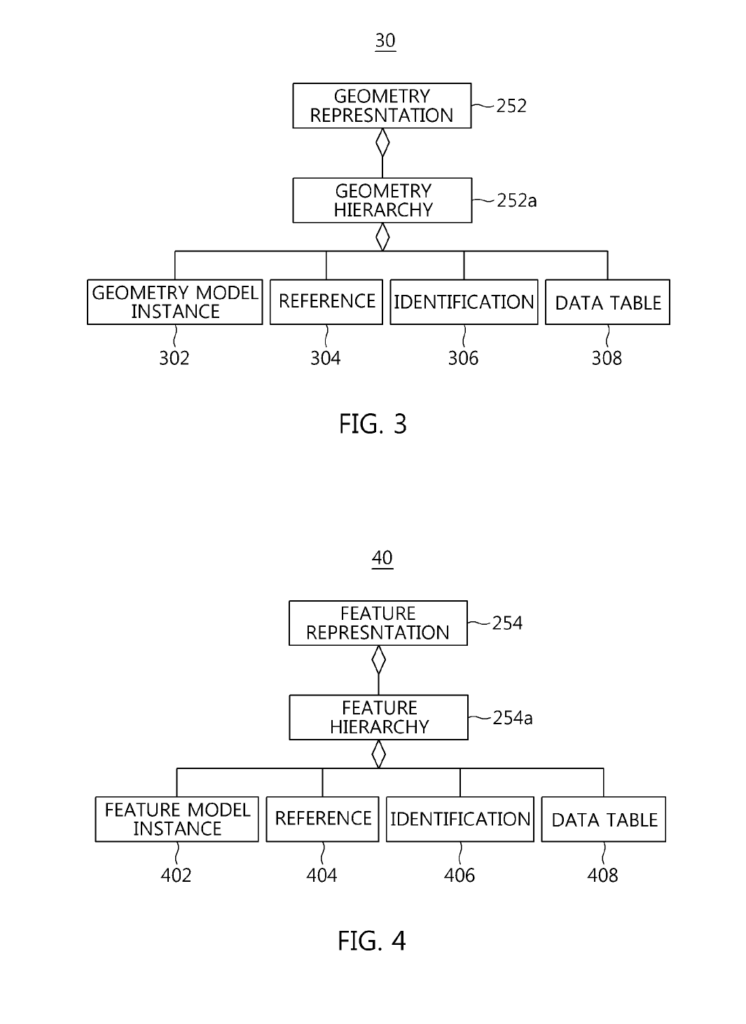

Referring to FIG. 3, the model structure 30 of the geometry representation model 252 has a geometry model instance 302, a reference model 304, an identification model 306, and a data table 308 as lower class models of the geometry representation model 252. That is, the geometry representation model 252 includes the geometry structure information of environment data. In order to represent the geometry structure information, four lower class models, that is, the geometry model instance 302, the reference model 304, the identification model 306, and the data table 308, are required.

The geometry model instance 302 corresponds to a model instance having the geometry structure information of the environment data. The geometry model instance 302 is represented by at least three polygon instances.

The reference model 304 has information indicative of a reference relation between geometry model instances. That is, the reference model 304 takes charge of a reference between geometry model instances having the geometry structure information. Accordingly, the developer of the cyber-physical system may distinguish geometry model instances having commonness or differences from each other by means of the reference model 304.

The identification model 306 has the identification information of the geometry model instances. That is, the identification model 306 represents the identification of a model having geometry structure information. In this case, a single model has one identification or two or more identifications.

The data table 308 represents the geometry structure information of environment data in the format of a table. In this case, the data table 308 may represent one or more of a property value, a property table, behavior, and transformation information related to the geometry structure of the environment data in the format of a table.

Meanwhile, referring to FIG. 4, the model structure 40 of the feature representation model 254 has a feature model instance 402, a reference model 404, an identification model 406, and a data table 408 as lower class models of the feature representation model 254. That is, the feature representation model 254 includes the feature information of the environment data. In order to represent the corresponding feature information, four lower class models, that is, the feature model instance 402, the reference model 404, the identification model 406, and the data table 408, are required.

The feature model instance 402 corresponds to a model instance having the two-dimensional (2D) or three-dimensional (3D) information of environment data. The feature model instance 402 is defined by point features, linear features, areal features, and/or volume features so as to represent the features of the environment data.

The reference model 404 has information indicative of a reference relation between feature model instances. That is, the reference model 404 takes charge of a reference between feature model instances having feature information. Accordingly, the developer of the cyber-physical system may distinguish feature model instances having commonness or differences from each other by means of the reference model 404.

The identification model 406 has the identification information of feature model instances. That is, the identification model 406 represents the identification of a model having feature information. In this case, a single model has one identification or two or more identifications.

The data table 408 represents the feature information of environment data in the format of a table. In this case, the data table 408 may represent one or more of a property value, a property table, behavior, and transformation information related to the features of environment data in the format of a table.

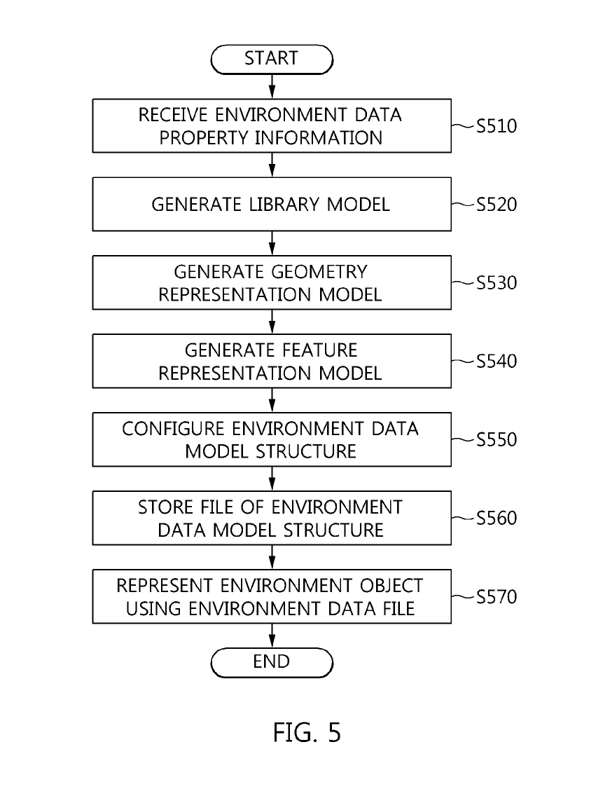

Hereinafter, a method of representing an environment object in a cyber-physical system using an environment data model structure according to the present invention will be described in detail with reference to FIGS. 5 to 7. Repeated descriptions of identical components described in the system for representing an environment object in a cyber-physical system using an environment data model structure as described above with reference to FIGS. 1 to 4 will be omitted.

FIG. 5 is a flowchart showing a method of representing an environment object in a cyber-physical system using an environment data model structure according to the present invention.

Referring to FIG. 5, in the method of representing an environment object in a cyber-physical system using an environment data model structure according to the present invention, the property information input unit 120 receives the property information of environment data required to configure the model structure of environment data from a user at step S510. In this case, the property information received through the property information input unit 120 may include the type, description, geometry structure, and feature information of environment data that is an object, the model structure of which is to be configured, and information required to visualize and represent the corresponding environment data in the cyber-physical system.

Next, the model structure configuration unit 140 generates a library model for storing information required to visualize the environment data as an environment object on the cyber-physical system at step S520.

Further, the model structure configuration unit 140 generates a geometry representation model having the geometry structure information of the environment data at step S530 while generating a feature representation model having 2D or 3D information of the environment data at step S540. Although, in FIG. 5, the step S520 of generating the library model, the step S530 of generating the geometry representation model, and the step S540 of generating the feature representation model, for the environment data, are shown as being sequentially performed, the sequence of the performance of steps S520 to S540 is not limited thereto. Further, steps S520 to S540 may be performed in parallel regardless of sequence.

Then, the model structure configuration unit 140 configures the model structure 20 of environment data having a root 200 as a highest class model for a single piece of environment data, based on the library model, the geometry representation model, and the feature representation model, generated at steps S520 to S540, as shown in FIG. 2, at step S550. In this case, the model structure 20 of the environment data configured by the model structure configuration unit 140 may further include a description model 210, an access model 220, and a point-of-contact model 230 as the lower class models of the root 200 in addition to the library model, the geometry representation model, and the feature representation model.

Then, the model structure configuration unit 140 provides the model structure 20 of the environment data configured at step S550 to the DB unit 160, and the DB unit 160 stores the information of the environment data model structure 20 configured by the model structure configuration unit 140 in the format of a file at step S560.

Finally, the environment object calculation unit 180 extracts the environment data file stored in the DB unit 160, and visually represents the environment object in the cyber-physical system using the extracted environment data file at step S570.

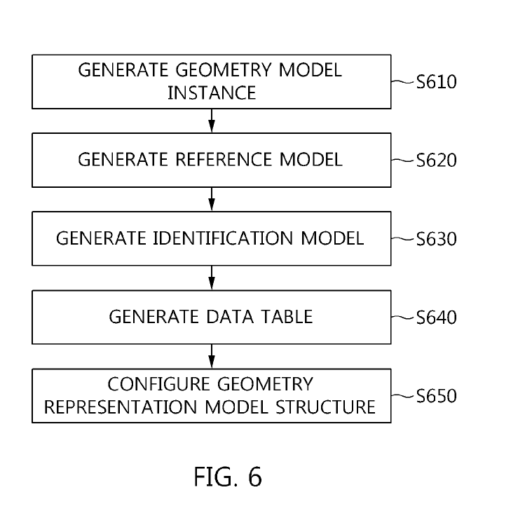

FIG. 6 is a flowchart showing in detail the geometry representation model generation step S530 in the method of representing an environment object in a cyber-physical system using an environment data model structure according to the present invention shown in FIG. 5.

Referring to FIG. 6, at the step S530 of generating the geometry representation model, the model structure configuration unit 140 generates geometry model instances having the geometry structure information of the environment data at step S610.

Further, the model structure configuration unit 140 individually generates a reference model indicative of a reference relation between the geometry model instances, an identification model having the identification information of the geometry model instances, and a data table representing the geometry structure information of the environment data in the format of a table at steps S620 to S640. Although, in FIG. 6, the step S610 of generating the geometry model instances, the step S620 of generating the reference model, the step S630 of generating the identification model, and the step S640 of generating the data table, for the environment data, are shown as being sequentially performed, the sequence of the performance of steps S610 to S640 is not limited thereto. Further, steps S610 to S640 may be performed in parallel regardless of sequence.

Then, the model structure configuration unit 140 configures a model structure 30 having a geometry representation model 252 as a highest class model, as shown in FIG. 3, based on the geometry model instances, the reference model, the identification model, and the data table, generated at steps S610 to S640, at step S650.

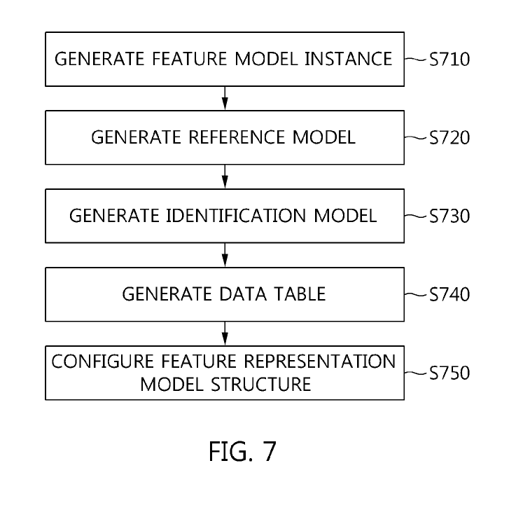

FIG. 7 is a flowchart showing in detail the feature representation model generation step S540 in the method of representing an environment object in a cyber-physical system using an environment data model structure according to the present invention shown in FIG. 5.

Referring to FIG. 7, at the step S540 of generating the feature representation model, the model structure configuration unit 140 generates a feature model instance indicative of model instances having feature information (2D or 3D information) of the environment data at step S710.

Further, the model structure configuration unit 140 individually generates a reference model indicative of a reference relation between feature model instances, an identification model having the identification information of the feature model instances, and a data table representing the feature information of the environment data in the format of a table, at steps S720 to S740. Although, in FIG. 7, the step S710 of generating the feature model instances, the step S720 of generating the reference model, the step S730 of generating the identification model, and the step S740 of generating the data table, for the environment data, are shown as being sequentially performed, the sequence of the performance of steps S710 to 740 is not limited thereto. Steps S710 to S740 may be performed in parallel regardless of the sequence thereof.

Thereafter, the model structure configuration unit 140 configures a model structure 40 having a feature representation model 254 as a highest class model, as shown in FIG. 4, based on the feature model instance, the reference model, the identification model, and the data table generated at steps S710 to S740, at step S750.

Meanwhile, the method of representing an environment object in a cyber-physical system using an environment data model structure according to the present invention may be implemented as a program that can be executed by various computer means. In this case, the program may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter.

In accordance with the present invention, there is an advantage in that an integrated environment that may be utilized in a cyber-physical system is defined, and the model structure of environment data required to represent an environment object is presented, so that environment data developed in a specific domain environment may be efficiently managed, and environment data developed between domains may be commonly utilized, thus reducing cost and time required by a developer to design a cyber-physical system.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method of representing an environment object in a cyber-physical system using an environment data model structure, comprising:
generating a library model for storing information required to visualize environment data as an environment object in a cyber-physical system;
generating a geometry representation model having geometry structure information of the environment data;
generating a feature representation model having two-dimensional (2D) or three-dimensional (3D) information of the environment data;
configuring a model structure of the environment data including the library model, the geometry representation model, and the feature representation model;
storing an environment data file having information about the model structure of the environment data in a database (DB); and
visually representing the environment object in the cyber-physical system using the environment data file stored in the DB.

2. The method of claim 1, wherein generating the geometry representation model comprises generating a geometry model instance indicative of a model instance having geometry structure information of the environment data.

3. The method of claim 2, wherein the geometry model instance is represented by at least three polygon instances.

4. The method of claim 2, wherein generating the geometry representation model further comprises:
generating a reference model indicative of a reference relation between geometry model instances;
generating an identification model having identification information of the geometry model instances; and
generating a data table representing geometry structure information of the environment data in a format of a table.

5. The method of claim 4, wherein the data table is a table in which one or more of a property value, a property table, behavior, and transformation information related to a geometry structure of the environment data are represented in a format of a table.

6. The method of claim 1, wherein generating the feature representation model comprises generating a feature model instance indicative of a model instance having 2D or 3D information of the environment data.

7. The method of claim 6, wherein the feature model instance is defined by point features, linear features, areal features, or volume features.

8. The method of claim 6, wherein generating the feature representation model further comprises:
generating a reference model indicative of a reference relation between feature model instances;
generating an identification model having identification information of the feature model instances; and
generating a data table representing 2D or 3D information of the environment data in a format of a table.

9. The method of claim 8, wherein the data table is a table in which one or more of a property value, a property table, behavior, and transformation information related to 2D or 3D features of the environment data are represented in a format of a table.

10. A computer-readable storage medium storing a program for executing the method as set forth in claim 1.
